(19) United States
(12) Patent Application Publication
(10) Pub. No.: US 2017/0275713 A1
(43) Pub. Date: Sep. 28, 2017

(54) COMPOSITIONS AND METHODS FOR TREATING LEATHER

(71) Applicant: Purdue Research Foundation, West Lafayette, IN (US)

(72) Inventors: Sean Anderson, West Lafayette, IN (US); Evan Anderson, West Lafayette, IN (US); Sara Richert, West Lafayette, IN (US); Troy Tate, Kokomo, IN (US)

(21) Appl. No.: 15/596,133

(22) Filed: May 16, 2017

Related U.S. Application Data
(63) Continuation of application No. PCT/US2015/061041, filed on Nov. 17, 2015.
(60) Provisional application No. 62/106,491, filed on Jan. 22, 2015.
(60) Provisional application No. 62/081,377, filed on Nov. 18, 2014.

(51) Int. Cl. C14C 11/00; C08L 91/06; A23D 7/00; C09G 1/04; C09G 1/10

(52) U.S. Cl. CPC C14C 11/003; C09G 1/04; C09G 1/10; A23D 7/003; C08L 91/06

(57) ABSTRACT

The present disclosure provides a composition for treating leather and similar materials. The composition comprises from about 40% (w/w) to about 60% (w/w) of an oil obtained from natural sources; from about 1% (w/w) to about 15% (w/w) of a wax obtained from natural sources; and from about 20% (w/w) to about 50% (w/w) of water. The present disclosure also provides a method for treating a leather article and a process for the preparation of an emulsion composition.

### RELATED APPLICATIONS

This application is a continuation of PCT/US2015/061041, filed Nov. 17, 2015, claims priority to U.S. Provisional Patent Application Ser. No. 62/106,491, filed Jan. 22, 2015, and U.S. Provisional Patent Application Ser. No. 62/081,377, filed Nov. 18, 2014, all of which are hereby incorporated herein by reference in their entireties.

### BACKGROUND

The present disclosure relates to a composition for treating and conditioning leather articles, such as, for example, saddles, boots, shoes, purses, chaps, handbags, wallets, furniture, jackets, briefcases, and the like. More particularly, the present disclosure relates to a composition for treating and conditioning leather articles utilizing a combination of a natural oil and a natural wax.

Leather polish and water resistant treatments are known in the art. Modern leather polishes are typically made from a mix of natural and synthetic components, including turpentine, paraffin wax, petroleum ethers, other refined petroleum products, and silicone based products. Unfortunately, many of these commercially available leather polish and water resistant treatments can be toxic with significant exposure and must be used in well-ventilated areas with care taken to protect the human user, clothes, carpet, and furniture. Petroleum-derived ingredients have some particular disadvantages with regards to toxicity to humans and the environment. Even many naturally-derived ingredients such as turpentine, a classic ingredient in many furniture polishes, have some disadvantages such as unpleasant odors. Thus, even naturally-derived components have disadvantages, and it would be advantageous to formulate leather treatments without these undesirable components.

U.S. Pat. No. 5,614,005 to Leung discloses a leather shoe care composition that provides a shine and is water and salt resistant. U.S. Pat. No. 4,804,413 discloses a non-caking shoe polish. Unfortunately, however, the compositions in these patents contain components such as petroleum benzine (petroleum ether) and turpentine oil, which are undesirable from an environmental perspective and, as noted above, exposure to these chemicals may pose health risks. It is also known in the art that when using compositions containing paraffin wax that blooming often occurs on the surface of the leather.

Some attempts have been made to utilize natural materials in leather treatment compositions. One attempt was a leather dressing composition including Japan wax, paraffin oil, neat's foot oil, and beef oil. Unfortunately, however, the paraffin oil makes the composition a less than desirable treatment based on its toxicity concerns.

Another attempt was a composition for softening leather by stuffing it with a paste made of rye meal, beeswax, resin, molasses, and cod oil. One disadvantage with the composition is that the composition requires frequent application, which is inconvenient for the human user. Another disadvantage is that it is difficult to apply the composition to leather.

Accordingly, there exists a need for an environmentally friendly composition for treating leather that is easy to apply, is long lasting, uses natural ingredients, and is environmentally friendly.

### SUMMARY

The present disclosure addresses the problems discussed hereinabove and provides related advantages as well by providing a composition for treating leather and similar materials. The composition comprises from about 40% (w/w) to about 60% (w/w) of an oil obtained from natural sources; from about 1% (w/w) to about 15% (w/w) of a wax obtained from natural sources; and from about 20% (w/w) to about 50% (w/w) of water.

Another aspect of the present disclosure provides a method for treating a leather article. The method comprises applying onto the article a composition. The composition comprises from about 40% (w/w) to about 60% (w/w) of an oil obtained from natural sources; from about 1% (w/w) to about 15% (w/w) of a wax obtained from natural sources; and from about 20% (w/w) to about 50% (w/w) of water.

A further aspect of the present disclosure provides a process for the preparation of an emulsion composition including water and having oil and wax obtained from natural sources. The process comprises adding the oil and wax to a container; stirring the oil and wax with sufficient heat to form a mixture; allowing the mixture to cool; adding one or more thickeners and one or more neutralizers to the mixture with stirring; and rapidly cutting the water into the mixture to complete the emulsion.

The present disclosure provides several advantages. One advantage of the compositions made in accordance with an embodiment of the present disclosure is that the compositions can be formed from natural ingredients and thus are environmentally friendly. Compositions made in accordance with this disclosure can thus avoid the inclusion of toxic synthetic and petroleum products. Another advantage of the compositions made in accordance with another embodiment of the present disclosure is that the primary ingredients—natural oil and natural wax—are relatively inexpensive. A further advantage of the compositions made in accordance with another embodiment of the present disclosure is that the manufacturing process of the compositions can be completed quickly and does not require many steps. Thus, the compositions made in accordance with this disclosure can be produced efficiently and economically. Yet another advantage of the compositions made in accordance with another embodiment of the present disclosure is that the compositions are easy to apply to leather, are rapidly absorbed in leather, and impart long life to the leather being treated. A still further advantage of the compositions made in accordance with another embodiment of the present disclosure is that the compositions are easily absorbed and contained by the leather thereby retaining the natural appearances and luster of the leather surface for a long lasting duration. Another advantage of another embodiment of the present disclosure is that after the composition is applied onto a leather article, the composition leaves a soft and treated leather surface without being either sticky or slippery.

Additional embodiments, aspects, and advantages of this disclosure will be apparent from the following description.

### BRIEF DESCRIPTION OF THE DRAWINGS

FIG. 1 is a flow chart illustrating the process for preparing an exemplary embodiment.

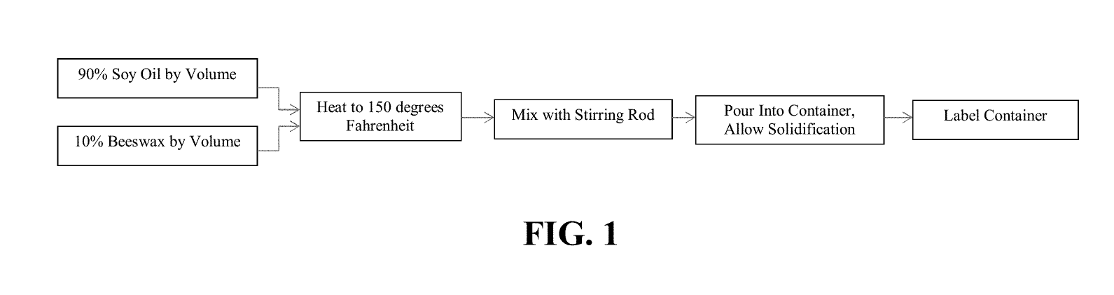

FIG. 2 is a picture of a shoe treated with an embodiment according to this disclosure next to an untreated reference shoe.

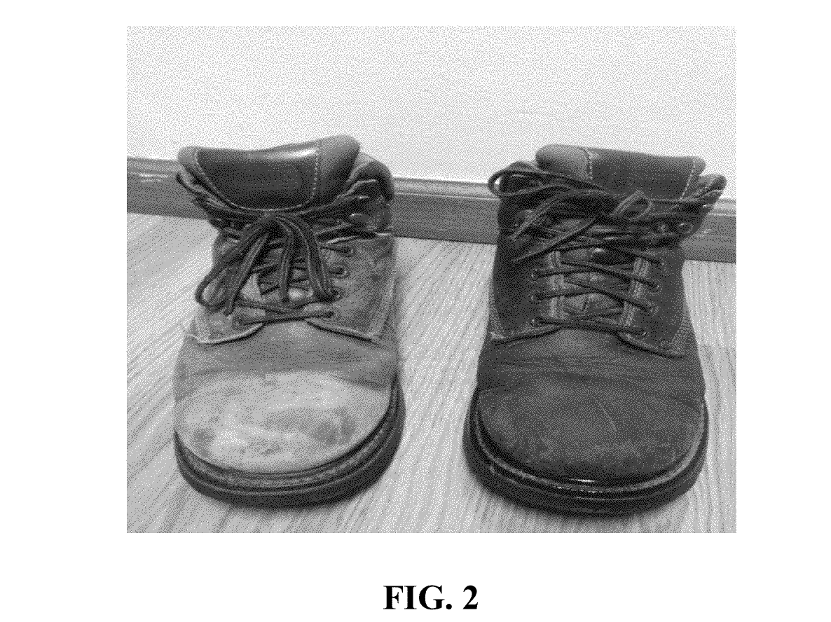

FIG. 3 is a picture of a single leather shoe wherein half of the shoe has been treated with an embodiment according to this disclosure and the other half has not.

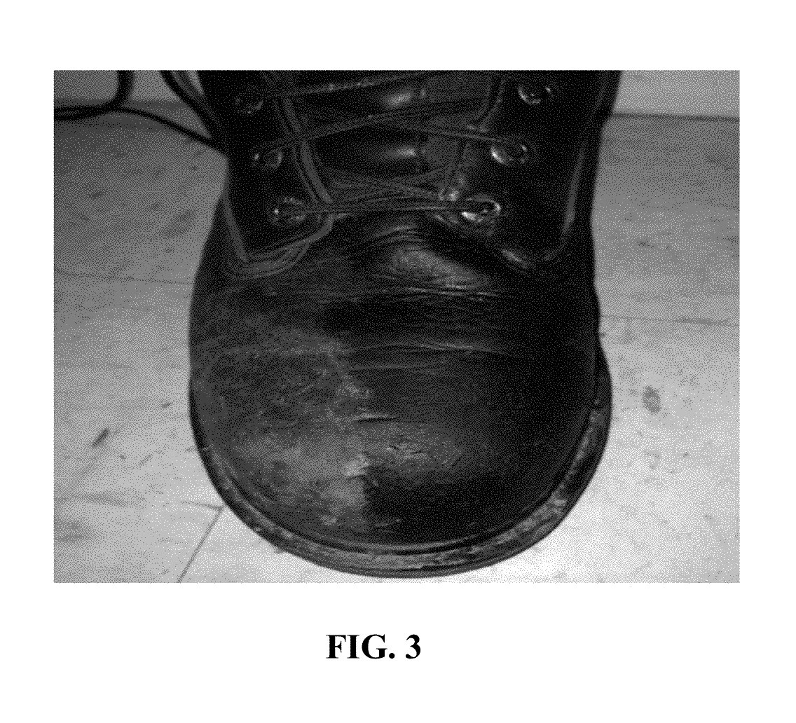

### DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of this disclosure.

The present disclosure provides a composition for treating leather and similar materials. The composition comprises an oil obtained from natural sources, a wax obtained from natural sources, and water.

The oil utilized in accordance with the present disclosure is obtained from natural sources. As used herein, “natural sources” refers to plant sources, insect sources, and animal sources. The oil is utilized in the composition as a humectant, among many other functions, to provide retention and preservation of moisture in the composition. However, one of ordinary skill in the art understands that the oil can have many other functions other than being a humectant.

In some embodiments of the present disclosure, the oil is obtained from plant sources, including, for example, cottonseed, corn, sunflower, sunflower seed, rapeseed, soybean, olive, coconut, palm, palm kernel, peanut, beechnut, castor, cocoa butter, groundnut, hazelnut, nutmeg butter, orange peel, poppy, poppy seed, raisin seed, rice bran, safflower, sesame, walnut, camphor, cashew, creosote, linseed, oiticica, perilla, pine, rosin, tung, and the like. Also included herein is “vegetable oil,” which refers to a triglyceride extracted from a plant. Canola oil can also be utilized in some embodiments of the present disclosure. As used herein, “canola oil” refers to an oil produced from the seed of any of several varieties of the rape plant, and to those plants, namely a cultivar of either rapeseed (Brassica napus L.) or field mustard/turnip rape (Brassica rapa subsp. Oleifera, syn. B. campestris L.). In some embodiments, canola oil is rapeseed oil. One of skill in the art understands that “vegetable oil” and “canola oil” may refer to many commercial products and the utilization of such products in the present disclosure is envisioned.

In some embodiments of the present disclosure, the oil is obtained from animal sources, such as fish oil, neatsfoot oil, lard, tallow, and lanolin, to name a few. As used herein, “fish oil” refers to oil obtained from any species of fish. In some embodiments, the oil is a combination of two or more oils.

In some embodiments of the present disclosure, the amount of oil obtained from natural sources in the composition can vary. In some embodiments, the oil is present in the composition in an amount from about 40% (w/w) to about 60% (w/w). As used herein, “% (w/w)” means percent by weight, including, for example, weight of a particular component of the composition/weight of the entire composition. In some embodiments, the oil is present in the composition in an amount from about 45% (w/w) to about 60% (w/w). In some embodiments, the oil is present in the composition in an amount from about 50% (w/w) to about 60% (w/w). In some embodiments, the oil is present in the composition in an amount from about 50% (w/w) to about 55% (w/w). In some embodiments, the oil is present in the composition in an amount from about 55% (w/w) to about 60% (w/w). In some embodiments, the oil is present in the composition in an amount from about 52% (w/w) to about 58% (w/w).

In some embodiments of the present disclosure, the oil obtained from natural sources is soybean oil. A commercially available soybean oil suitable for the present disclosure is Golden Chef® Soybean Salad Oil, UPC No. 00751884999125, which is available from Stratas Foods LLC. Stratas Foods LLC is located at 7130 Goodlett Farms Parkway, Suite 200, Memphis, Tenn. 38016, USA with its website at www.stratasfood.com.

Soybean oils are comprised of triglycerides. A triglyceride is an ester derived from glycerol and three fatty acid chains. These fatty acid chains can be classified as saturated, monounsaturated, and polyunsaturated fatty acids, depending on the type of chemical bonds present. The mono- and polyunsaturated fatty acids have double bonds in the “cis” formation. These bonds can be easily broken down by oxygen, which produces compounds that make the oil rancid. Rancidity produces off-flavors and/or unpleasant odors in foods. To control this rancidity problem, food manufacturers use hydrogenated soybean oils. These are not as likely to break down and will produce a product with a longer shelf life.

Hydrogenation is a chemical process that adds hydrogen atoms to the available double bonds in the soybean oil. Soybean oil, which contains unsaturated fatty acids like oleic and linoleic acid, is heated with metal catalysts in the presence of pressurized hydrogen gas. Hydrogen is incorporated into the fatty acid molecules and the molecules become saturated with hydrogen. Oleic acid (C18:1) and linoleic acid (C18:2) are both converted to stearic acid (C18:0) when fully saturated. As the degree of hydrogenation increases, the amount of saturated fats increases and the amount of mono- and polyunsaturated fats decreases. Completely hydrogenated soybean oil is solid at room temperature. Because fully saturated fats are too solid to use as food additives, manufacturers use partially hydrogenated oils. These oils are also produced at high temperatures with metal catalysts and pressurized hydrogen, but the process is stopped when the oil has the proper consistency for its application. Partially hydrogenated fats are liquid at room temperature and contain more saturated fatty acids than the original oil.

One of skill in the art will understand that several different soybean oils with many different degrees of hydrogenation (i.e., iodine value) are suitable for use with this disclosure. Although the amount of soybean oil that is preferred in the composition of this disclosure will change based on the degree of the soybean oil's hydrogenation, the skilled artisan understands that the composition's formula of soybean oil to beeswax, in the embodiments that beeswax is utilized, can be adjusted to account for the various degrees of hydrogenation of the starting soybean oil.

In some embodiments of the present disclosure, the amount of the soybean oil in the composition can vary. In some embodiments, the soybean oil is present in the composition in an amount from about 40% (w/w) to about 60% (w/w). In some embodiments, the soybean oil is present in the composition in an amount from about 45% (w/w) to about 60% (w/w). In some embodiments, the soybean oil is present in the composition in an amount from about 50% (w/w) to about 60% (w/w). In some embodiments, the soybean oil is present in the composition in an amount from about 50% (w/w) to about 55% (w/w). In some embodiments, the soybean oil is present in the composition in an amount from about 55% (w/w) to about 60% (w/w). In some embodiments, the soybean oil is present in the composition in an amount from about 52% (w/w) to about 58% (w/w).

The wax utilized in accordance with the present disclosure is obtained from natural sources. In some embodiments, the wax is utilized in the composition as a humectant and a thickener, among many other functions. However, one of ordinary skill in the art understands that the wax can have many other functions other than being a humectant and thickener. Waxes that find utility in the present disclosure include, but are not limited to, beeswax, candelilla wax, carnauba (palm) wax, orange wax, Chinese wax, and bayberry wax. In some embodiments, the wax is a combination of two or more waxes.

In some embodiments of the present disclosure, the amount of wax obtained from natural sources in the composition can vary. In some embodiments, the wax is present in the composition in an amount from about 1% (w/w) to about 15% (w/w). In some embodiments, the wax is present in the composition in an amount from about 1% (w/w) to about 10% (w/w). In some embodiments, the wax is present in the composition in an amount from about 1% (w/w) to about 5% (w/w). In some embodiments, the wax is present in the composition in an amount from about 5% (w/w) to about 10% (w/w). In some embodiments, the wax is present in the composition in an amount from about 2% (w/w) to about 8% (w/w).

In some embodiments of the present disclosure, the wax obtained from natural sources is beeswax. A commercially available beeswax suitable for the present disclosure is Nature's Oil 100% Pure Yellow Beeswax, UPC No. 111280051443, which is available from Nature's Oil, 1800 Miller Parkway Streetsboro, Ohio 44241, www.natures-oil.com. Also contemplated for use in the present disclosure are some of the beeswaxes provided by Stratas Foods LLC. These exemplary embodiments are not intended to be an exhaustive listing of soybean oils and beeswaxes that are suitable for use with the present disclosure. It is also envisioned that many commercially available soybean oils and beeswaxes may be utilized as desired.

In some embodiments of the present disclosure, the amount of the beeswax in the composition can vary. In some embodiments, the beeswax is present in the composition in an amount from about 1% (w/w) to about 15% (w/w). In some embodiments, the beeswax is present in the composition in an amount from about 1% (w/w) to about 10% (w/w). In some embodiments, the beeswax is present in the composition in an amount from about 1% (w/w) to about 5% (w/w). In some embodiments, the beeswax is present in the composition in an amount from about 5% (w/w) to about 10% (w/w). In some embodiments, the beeswax is present in the composition in an amount from about 2% (w/w) to about 8% (w/w).

Water is utilized in the composition of the present disclosure. The water is utilized in the composition as a diluent, among many other functions. However, one of ordinary skill in the art understands that the water can have many other functions other than being a diluent. In some embodiments, the amount of water in the composition can vary. In some embodiments, the water is present in the composition in an amount from about 20% (w/w) to about 50% (w/w). In some embodiments, the water is present in the composition in an amount from about 25% (w/w) to about 45% (w/w). In some embodiments, the water is present in the composition in an amount from about 30% (w/w) to about 40% (w/w). In some embodiments, the water is present in the composition in an amount from about 30% (w/w) to about 35% (w/w). In some embodiments, the water is present in the composition in an amount from about 35% (w/w) to about 40% (w/w). In some embodiments, the water is present in the composition in an amount from about 32% (w/w) to about 38% (w/w).

A thickener is utilized in some embodiments of the present disclosure. As used herein, the term “thickener” refers to a thickening agent, which is a substance that can increase the viscosity of a liquid without substantially changing the liquid's other properties. A non-limiting list of thickener's that can be utilized in the composition of the present disclosure include alginic acid, sodium alginate, potassium alginate, ammonium alginate, calcium alginate, propylene glycol alginate (propane-1,2-diol alginate), agar, carrageenan (including furcelleran), processed euchema seaweed, bakers yeast glycan, arabinogalactan, locust bean gum, oat gum, guar gum, tragacanth gum, gum arable (acacia gum), xanthan gum, karaya gum, tara gum, gellan gum, gum ghatti, curdlan gum, konjac flour, soybean hemicellulose, pectin, cellulose, microcrystalline cellulose, powdered cellulose, methyl cellulose, ethyl cellulose, hydroxypropyl cellulose, hydroxypropyl methyl cellulose, methyl ethyl cellulose, sodium carboxymethyl cellulose, ethyl hydroxyethyl cellulose, cross-linked sodium carboxymethyl cellulose, maltodextrin, oleic acid, cetyl alcohol, oleyl alcohol, sodium chloride, cetearyl alcohol, alcohol, gum arabic, acrylic polymers, cocamidopropyl betaine, cocamidopropylamine oxide, carbomer, siliciumdioxide, magnesium and/or aluminium silicates, stearic acid, stearyl alcohol polysaccharides, and combinations thereof, to name a few. In some embodiments, the thickener is selected from the group consisting of carbomer, stearic acid, cetyl alcohol, and combinations thereof.

A commercially available carbomer suitable for this disclosure is Pemulen® TR-2 polymeric emulsifier, available from Lubrizol Advanced Materials, 9911 Brecksville Road, Cleveland, Ohio 44141-3247, USA. Stearic acid is commercially available from Nexeo® Solutions, LLC, 3 Waterway Square Place, Suite 1000, The Woodlands, Tex. 77380. Cetyl alcohol is also commercially available from Nexeo® Solutions, LLC. These exemplary embodiments illustrate only a few of the exemplary thickeners according to the present disclosure. One of ordinary skill in the art would be able to substitute other suitable thickeners in accordance with the present disclosure.

In some embodiments of the present disclosure, the amount of the thickener in the composition can vary. In some embodiments, the thickener is present in the composition in an amount from about 0.1% (w/w) to about 5% (w/w). In some embodiments, the thickener is present in the composition in an amount from about 0.1% (w/w) to about 4.5% (w/w). In some embodiments, the thickener is present in the composition in an amount from about 0.1% (w/w) to about 4% (w/w). In some embodiments, the thickener is present in the composition in an amount from about 0.1% (w/w) to about 3.5% (w/w). In some embodiments, the thickener is present in the composition in an amount from about 0.1% (w/w) to about 3% (w/w). In some embodiments, the thickener is present in the composition in an amount from about 0.1% (w/w) to about 2.5% (w/w). In some embodiments, the thickener is present in the composition in an amount from about 0.1% (w/w) to about 2% (w/w). In some embodiments, the thickener is present in the composition in an amount from about 0.1% (w/w) to about 1.5% (w/w). In some embodiments, the thickener is present in the composition in an amount from about 0.1% (w/w) to about 1% (w/w). In some embodiments, the thickener is present in the composition in an amount from about 0.1% (w/w) to about 0.5% (w/w).

In some embodiments of the present disclosure, the thickener is carbomer. In some embodiments, the amount of the carbomer in the composition can vary. In some embodiments, the carbomer is present in the composition in an amount from about 0.1% (w/w) to about 5% (w/w). In some embodiments, the carbomer is present in the composition in an amount from about 0.1% (w/w) to about 4.5% (w/w). In some embodiments, the carbomer is present in the composition in an amount from about 0.1% (w/w) to about 4% (w/w). In some embodiments, the carbomer is present in the composition in an amount from about 0.1% (w/w) to about 3.5% (w/w). In some embodiments, the carbomer is present in the composition in an amount from about 0.1% (w/w) to about 3% (w/w). In some embodiments, the carbomer is present in the composition in an amount from about 0.1% (w/w) to about 2.5% (w/w). In some embodiments, the carbomer is present in the composition in an amount from about 0.1% (w/w) to about 2% (w/w). In some embodiments, the carbomer is present in the composition in an amount from about 0.1% (w/w) to about 1.5% (w/w). In some embodiments, the carbomer is present in the composition in an amount from about 0.1% (w/w) to about 1% (w/w). In some embodiments, the carbomer is present in the composition in an amount from about 0.1% (w/w) to about 0.5% (w/w). In some embodiments, the carbomer is present in the composition in an amount from about 0.1% (w/w) to about 0.4% (w/w). In some embodiments, the carbomer is present in the composition in an amount from about 0.1% (w/w) to about 0.3% (w/w). In some embodiments, the carbomer is present in the composition in an amount from about 0.1% (w/w) to about 0.2% (w/w).

In some embodiments of the present disclosure, the thickener is stearic acid. In some embodiments, the amount of the stearic acid in the composition can vary. In some embodiments, the stearic acid is present in the composition in an amount from about 0.1% (w/w) to about 5% (w/w). In some embodiments, the stearic acid is present in the composition in an amount from about 0.1% (w/w) to about 4.5% (w/w). In some embodiments, the stearic acid is present in the composition in an amount from about 0.1% (w/w) to about 4% (w/w). In some embodiments, the stearic acid is present in the composition in an amount from about 0.1% (w/w) to about 3.5% (w/w). In some embodiments, the stearic acid is present in the composition in an amount from about 0.1% (w/w) to about 3% (w/w). In some embodiments, the stearic acid is present in the composition in an amount from about 0.1% (w/w) to about 2.5% (w/w). In some embodiments, the stearic acid is present in the composition in an amount from about 0.1% (w/w) to about 2% (w/w). In some embodiments, the stearic acid is present in the composition in an amount from about 0.1% (w/w) to about 1.5% (w/w). In some embodiments, the stearic acid is present in the composition in an amount from about 0.1% (w/w) to about 1% (w/w). In some embodiments, the stearic acid is present in the composition in an amount from about 0.1% (w/w) to about 0.5% (w/w). In some embodiments, the stearic acid is present in the composition in an amount from about 0.1% (w/w) to about 0.4% (w/w). In some embodiments, the stearic acid is present in the composition in an amount from about 0.1% (w/w) to about 0.3% (w/w). In some embodiments, the stearic acid is present in the composition in an amount from about 0.1% (w/w) to about 0.2% (w/w).

In some embodiments of the present disclosure, the thickener is cetyl alcohol. In some embodiments, the amount of the cetyl alcohol in the composition can vary. In some embodiments, the cetyl alcohol is present in the composition in an amount from about 0.1% (w/w) to about 5% (w/w). In some embodiments, the cetyl alcohol is present in the composition in an amount from about 0.1% (w/w) to about 4.5% (w/w). In some embodiments, the cetyl alcohol is present in the composition in an amount from about 0.1% (w/w) to about 4% (w/w). In some embodiments, the cetyl alcohol is present in the composition in an amount from about 0.1% (w/w) to about 3.5% (w/w). In some embodiments, the cetyl alcohol is present in the composition in an amount from about 0.1% (w/w) to about 3% (w/w). In some embodiments, the cetyl alcohol is present in the composition in an amount from about 0.1% (w/w) to about 2.5% (w/w). In some embodiments, the cetyl alcohol is present in the composition in an amount from about 0.1% (w/w) to about 2% (w/w). In some embodiments, the cetyl alcohol is present in the composition in an amount from about 0.1% (w/w) to about 1.5% (w/w). In some embodiments, the cetyl alcohol is present in the composition in an amount from about 0.1% (w/w) to about 1% (w/w). In some embodiments, the cetyl alcohol is present in the composition in an amount from about 0.1% (w/w) to about 0.5% (w/w). In some embodiments, the cetyl alcohol is present in the composition in an amount from about 0.1% (w/w) to about 0.4% (w/w). In some embodiments, the cetyl alcohol is present in the composition in an amount from about 0.1% (w/w) to about 0.3% (w/w). In some embodiments, the cetyl alcohol is present in the composition in an amount from about 0.1% (w/w) to about 0.2% (w/w).

In some embodiments of the present disclosure, the cetyl alcohol is present in the composition in an amount from about 1% (w/w) to about 5% (w/w). In some embodiments, the cetyl alcohol is present in the composition in an amount from about 1.5% (w/w) to about 4.5% (w/w). In some embodiments, the cetyl alcohol is present in the composition in an amount from about 2% (w/w) to about 4% (w/w).

A neutralizer is utilized in some embodiments of the present disclosure. As used herein, the term “neutralizer” refers to a “neutralizing agent,” which has its ordinary meaning as understood by one of skill in the art. Non-limiting examples of neutralizing agents which may be utilized in the compositions of the present disclosure include alkali hydroxides such as sodium and potassium hydroxide; organic bases such as diethanolamine (DEA), triethanolamine (TEA), and aminomethyl propanol; amino acids such as arginine and lysine; and combinations thereof. In some embodiments, the neutralizer is triethanolamine. Triethanolamine is commercially available from Nexeo® Solutions, LLC.

In some embodiments of the present disclosure the amount of the neutralizer in the composition can vary. In some embodiments, the neutralizer is present in the composition in an amount from about 0.1% (w/w) to about 5% (w/w). In some embodiments, the neutralizer is present in the composition in an amount from about 0.1% (w/w) to about 4.5% (w/w). In some embodiments, the neutralizer is present in the composition in an amount from about 0.1% (w/w) to about 4% (w/w). In some embodiments, the neutralizer is present in the composition in an amount from about 0.1% (w/w) to about 3.5% (w/w). In some embodiments, the neutralizer is present in the composition in an amount from about 0.1% (w/w) to about 3% (w/w). In some embodiments, the neutralizer is present in the composition in an amount from about 0.1% (w/w) to about 2.5% (w/w). In some embodiments, the neutralizer is present in the composition in an amount from about 0.1% (w/w) to about 2% (w/w). In some embodiments, the neutralizer is present in the composition in an amount from about 0.1% (w/w) to about 1.5% (w/w). In some embodiments, the neutralizer is present in the composition in an amount from about 0.1% (w/w) to about 1% (w/w). In some embodiments, the neutralizer is present in the composition in an amount from about 0.1% (w/w) to about 0.5% (w/w). In some embodiments, the neutralizer is present in the composition in an amount from about 0.1% (w/w) to about 0.4% (w/w). In some embodiments, the neutralizer is present in the composition in an amount from about 0.1% (w/w) to about 0.3% (w/w). In some embodiments, the neutralizer is present in the composition in an amount from about 0.1% (w/w) to about 0.2% (w/w).

In some embodiments of the present disclosure, the neutralizer is triethanolamine. In some embodiments, the amount of the triethanolamine in the composition can vary. In some embodiments, the triethanolamine is present in the composition in an amount from about 0.1% (w/w) to about 5% (w/w). In some embodiments, the triethanolamine is present in the composition in an amount from about 0.1% (w/w) to about 4.5% (w/w). In some embodiments, the triethanolamine is present in the composition in an amount from about 0.1% (w/w) to about 4% (w/w). In some embodiments, the triethanolamine is present in the composition in an amount from about 0.1% (w/w) to about 3.5% (w/w). In some embodiments, the triethanolamine is present in the composition in an amount from about 0.1% (w/w) to about 3% (w/w). In some embodiments, the triethanolamine is present in the composition in an amount from about 0.1% (w/w) to about 2.5% (w/w). In some embodiments, the triethanolamine is present in the composition in an amount from about 0.1% (w/w) to about 2% (w/w). In some embodiments, the triethanolamine is present in the composition in an amount from about 0.1% (w/w) to about 1.5% (w/w). In some embodiments, the triethanolamine is present in the composition in an amount from about 0.1% (w/w) to about 1% (w/w). In some embodiments, the triethanolamine is present in the composition in an amount from about 0.1% (w/w) to about 0.5% (w/w). In some embodiments, the triethanolamine is present in the composition in an amount from about 0.1% (w/w) to about 0.4% (w/w). In some embodiments, the triethanolamine is present in the composition in an amount from about 0.1% (w/w) to about 0.3% (w/w). In some embodiments, the triethanolamine is present in the composition in an amount from about 0.1% (w/w) to about 0.2% (w/w).

The compositions of the present disclosure include in some embodiments those that also optionally contain one or more additives. Additives that can be utilized in the present disclosure include emulsifiers, stabilizers, colorants, fragrances, abrasives, adjuvants, combinations thereof, and the like that can be added as would be known by one of skill in the art. The amount of the additives to be included in the compositions of the present disclosure may be readily determined by one of skill in the art. However, in view of the core ingredients of oil and wax obtained from natural sources being environmentally friendly, one of skill in the art would preferably select additional components that are also environmentally friendly and natural.

In some embodiments of the present disclosure, the composition is a semi-solid. As used herein, the term “semi-solid” refers to a composition which, at room temperature, i.e., at a temperature of about 20° C. to about 25° C., has the consistency of a paste. As used herein, “° C.” means degrees Celsius. Semi-solid also refers to the condition which can be shaped into any configuration and handled like a solid in stationary or sub-stationary state at room temperature, but is given fluidity to a degree sufficient to be transferred to a surface of any hard shaped article by proper shearing force by hand of an ordinary man in the applying operation.

In some embodiments of the present disclosure, the semi-solid composition is a suspension. “Suspension” refers to a mixture containing solid particles that are sufficiently large for sedimentation. That is, the solute-like particles are large enough to settle out of a solvent-like phase sometime after their introduction.

In some embodiments of the present disclosure, the composition is an emulsion. In some embodiments, the composition is a semi-solid emulsion. As used herein, the term “emulsion” refers to a mixture of two or more liquids that are normally immiscible (unmixable or unblendable) and one liquid generally contains a dispersion of the other liquid(s). As one of skill in the art understands, two liquids can form different types of emulsions. As an example, oil and water can form, first, an oil-in-water emulsion, wherein the oil is the dispersed phase, and water is the dispersion medium. Second, oil and water can form a water-in-oil emulsion, wherein water is the dispersed phase and oil is the external phase. Multiple emulsions are also possible, including a “water-in-oil-in-water” emulsion and an “oil-in-water-in-oil” emulsion. In some embodiments, the emulsion is a water-in-oil emulsion. As used herein, the phrase “water-in-oil emulsion” means that water droplets are dispersed in oil. The amount of the water and oil as described in the present disclosure in the composition must be followed in order for the water-in-oil emulsion to form and remain a water-in-oil emulsion. The inventors have found that if the water and oil are substantially less than or greater than the desired proportions provided in the present disclosure, the water and oil will separate, forming two phases with the oil floating on top of the water.

In some embodiments, the oil is soybean oil and the wax is beeswax. Without being bound by any theory, it is believed that the oil component protects and waterproofs leather as well as non-leather items. Soybean oil is a natural lipid and readily mixes with natural beeswax to form a solid but remains a soft and workable substance when mixed in the desired proportions provided in the present disclosure. That is, the composition will easily spread onto leather. Without being bound by any theory, it is believed that the beeswax helps firm up the product so that it remains on the leather longer and also more effectively protects and waterproofs the leather.

The present disclosure also provides a method for treating a leather article. In some embodiments, the oil is soybean oil. In some embodiments, the wax is beeswax. In some embodiments, the composition further comprises a thickener. In some embodiments, the thickener is selected from the group consisting of carbomer, stearic acid, cetyl alcohol, and combinations thereof. In some embodiments, the composition further comprises a neutralizer. In some embodiments, the neutralizer is triethanolamine.

“Treating” refers to polishing, conditioning, waterproofing, and the like. Treatment with the composition of the present disclosure enhances the longevity and appearance of leather articles while simultaneously providing resistance to marring and water damage. As used herein, the phrase “leather article” refers to saddles, boots, shoes, purses, chaps, handbags, wallets, furniture, jackets, briefcases, and the like. One of skill in the art understands that leather articles includes generally any object that includes leather, and the compositions made in accordance with the present disclosure have a wide range of uses. While it is envisioned that a primary use will be to treat, waterproof, and polish leather articles, the inventive compositions could also be used as an effective treatment on non-leather items, e.g., faux leather and certain plastics such as, for example, vinyl.

The method according to the present disclosure comprises applying onto the leather article the composition of the present disclosure. “Applying” refers to spreading or smearing the composition of the present disclosure onto the leather article. Although not required for the methods of the present disclosure, application of the composition can be achieved by using a brush, cloth or electric polisher, to name a few applicators sufficient for the present disclosure. The present disclosure envisions that any suitable applicator may be utilized as desired.

In some embodiments of the present disclosure, the leather article is a leather saddle. One exemplary industry application of the composition of the present disclosure is leather saddles for horses. Many leather conditioners in the leather saddle industry are silicone based. The silicone can cause the treated leather saddle to be slippery. As one of skill in the art understands, using a slippery horse saddle is problematic for several reasons, primarily horse rider safety. For example, using a slippery silicone based saddle on a horse can cause the rider to be more likely to fall off of the horse, which can lead to serious injury or even death in extreme cases. The present disclosure addresses this problem by providing the composition of the present disclosure. The composition of the present disclosure utilizes an oil obtained from natural sources. In some embodiments, the oil is soybean oil. The soybean oil leaves a soft and treated surface without being either sticky or slippery. That is, it is the soybean oil that makes the composition of the present disclosure less slippery than silicone based compositions. Therefore, the concerns for horse rider safety from slippery silicone based saddles is substantially reduced or alleviated altogether by using the composition of the present disclosure.

The present disclosure also provides a process for the preparation of the composition of the present disclosure. In some embodiments, the process is for the preparation of an emulsion composition including water and having oil and wax obtained from natural sources. The process comprises adding the oil and wax to a container. The process further comprises stirring the oil and wax with sufficient heat to form a mixture. In some embodiments, the heat is applied with a Bunsen burner. The process further comprises allowing the mixture to cool. In some embodiments, the mixture is allowed to cool to about room temperature, i.e., at a temperature of about 20° C. to about 25° C. The process further comprises adding one or more thickeners and one or more neutralizers to the mixture with stirring. The process further comprises rapidly cutting the water into the mixture to complete the emulsion.

In some embodiments of the present disclosure, the oil and wax are heated to at least about 170° F. As used herein, “° F.” means degrees Fahrenheit. In some embodiments, the step of stirring the oil and wax is performed by a stirring device having an impeller. In some embodiments, the stirring speed of the impeller is at least about 120 RPM. In some embodiments, the rapid cutting is performed by a stirring device having a blade for cutting the mixture. In some embodiments, the blade has alternating teeth with angled leading and trailing edge profile. In some embodiments, the stirring speed of the blade is at least about 450 revolutions per minute (RPM). In some embodiments, the oil is soybean oil. In some embodiments, the wax is beeswax. In some embodiments, the thickener is selected from the group consisting of carbomer, stearic acid, cetyl alcohol, and combinations thereof. In some embodiments, the neutralizer is triethanolamine. In some embodiments, the emulsion is a water-in-oil emulsion. In some embodiments, the emulsion is a semi-solid.

The step of rapidly cutting the water into the mixture uses the centrifugal force and the shearing force provided by the stirring device to hit and cut the particles and further disperse the particles into the oil and water phases. The structure of the stirring device and the blade utilized in this step significantly affects the ability to form the emulsion and ultimately maintain the emulsion. Without the blade, the oil will merely be stirred around, which will eventually leave the oil floating on top of the water. Utilization of the blade disperses the water droplets into the oil. To achieve better efficiency and increase the production yield of the formed emulsion composition, the blade of the stirring device is preferably a cutter-type blade having cutting function. In some embodiments, the blade is a dispersion blade that features alternating teeth with angled leading and trailing edge profile for high shear action.

An example of an exemplary composition and method of making the composition is provided. In a 1000 ml Kimax beaker, 385 grams of Soy Salad Oil (commercial product number 104057), available from Stratas Foods LLC, is weighed out using a Mettler-Toledo balance (commercial product number PM4600). In the same beaker, 35 grams of Filter Bees Wax, available from Stratas Foods LLC is added. The mixture is heated over a standard Bunsen burner to a temperature of 170° F. measured with a Thermograph thermometer (commercial product number 5478542) with constant stirring using a Caframo® RZR1 laboratory stirrer and an Indco 1.5″ (inch) mixing impeller (commercial product number PP150) with a speed of approximately 120 RPM.

When the solution reaches the 170 ° F. temperature, the Bunsen burner is extinguished and the homogenous solution is allowed to cool to room temperature without stirring, which lasts about 2.5 hours. After cooling to approximately 80° F., 1.4 grams of Pemulen® TR-2, available from Lubrizol Advanced Materials, is added with stirring along with 7 grams of Stearic Acid, available from Nexeo Solutions, Inc., 2.1 grams of 85% Triethanolamine, available from Nexeo Solutions, Inc., and 17.5 grams of Cetyl Alcohol, available from Nexeo Solutions, Inc. The mixture is stirred for 1 hour to completely dissolve the Stearic Acid and Cetyl Alcohol and disperse the Pemulen® TR-2 and Triethanolamine. When the solution appears to be homogenous, which is after approximately 1 hour, 252 grams of distilled water is cut into the solution using an Indco 1⅝″ dispersion blade (commercial product number PL-DB158A) at a speed of approximately 450 RPM until the Pemulen® TR-2 thickener is activated, the solution becomes creamy, and the water-in-oil emulsion has been created, which is approximately 2 minutes. Optionally, small amounts of fragrances or dyes are added as desired during the process.

The resulting composition of the experiment discussed directly above exhibited good characteristics in terms of workability, effectiveness, and ease of the application.

While embodiments have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A composition for treating leather and similar materials, comprising:
from about 40% (w/w) to about 60% (w/w) of an oil obtained from natural sources;
from about 1% (w/w) to about 15% (w/w) of a wax obtained from natural sources; and
from about 20% (w/w) to about 50% (w/w) of water.

2. The composition of claim 1, wherein the oil is selected from the group consisting of soybean oil, cottonseed oil, corn oil, sunflower oil, canola oil, rapeseed oil, olive oil, coconut oil, palm oil, and combinations thereof.

3. The composition of claim 2, wherein the oil is soybean oil.

4. The composition of claim 1, wherein the wax is selected from the group consisting of beeswax, candelilla wax, carnauba wax, orange wax, Chinese wax, bayberry wax, and combinations thereof.

5. The composition of claim 4, wherein the wax is beeswax.

6. The composition of claim 1, further comprising a thickener.

7. The composition of claim 6, wherein the thickener is selected from the group consisting of carbomer, stearic acid, cetyl alcohol, and combinations thereof.

8. The composition of claim 7, wherein the thickener is present in the composition in an amount from about 0.1% (w/w) to about 5% (w/w).

9. The composition of claim 1, further comprising a neutralizer.

10. The composition of claim 9, wherein the neutralizer is triethanolamine.

11. The composition of claim 9, wherein the neutralizer is present in the composition in an amount from about 0.1% (w/w) to about 5% (w/w).

12. The composition of claim 1, wherein the oil obtained from natural sources comprises from about 50% (w/w) to about 60% (w/w) of soybean oil.

13. The composition of claim 12, wherein the wax obtained from natural sources comprises from about 1% (w/w) to about 10% (w/w) of beeswax.

14. The composition of claim 13, wherein the water is present in the composition in an amount from about 30% (w/w) to about 40% (w/w).

15. The composition of claim 14, further comprising from about 0.1% (w/w) to about 5% (w/w) of carbomer.

16. The composition of claim 15, further comprising from about 0.1% (w/w) to about 5% (w/w) of stearic acid.

17. The composition of claim 16, further comprising from about 1% (w/w) to about 5% (w/w) of cetyl alcohol.

18. The composition of claim 17, further comprising from about 0.1% (w/w) to about 5% (w/w) of triethanolamine.

19. The composition of claim 1, wherein the composition is a semi-solid.

20. The composition of claim 1, wherein the composition is an emulsion.

21. The composition of claim 20, wherein the emulsion is a water-in-oil emulsion.

22. The composition of claim 1, further comprising an additive selected from the group consisting of emulsifiers, stabilizers, colorants, fragrances, abrasives, adjuvants, and combinations thereof.

23. A semi-solid water-in-oil emulsion composition, comprising:
from about 50% (w/w) to about 60% (w/w) of soybean oil;
from about 1% (w/w) to about 10% (w/w) of beeswax;
from about 30% (w/w) to about 40% (w/w) of water;
a neutralizer; and
a thickener selected from the group consisting of carbomer, stearic acid, cetyl alcohol, and combinations thereof.

24. The composition of claim 23, wherein the neutralizer is triethanolamine.

25. The composition of claim 24, wherein the triethanolamine is present in the composition in an amount from about 0.1% (w/w) to about 1% (w/w).

26. The composition of claim 23, wherein the thickener comprises carbomer present in the composition in an amount from about 0.1% (w/w) to about 1% (w/w).

27. The composition of claim 26, wherein the thickener further comprises stearic acid present in the composition in an amount from about 0.1% (w/w) to about 2% (w/w).

28. The composition of claim 27, wherein the thickener further comprises cetyl alcohol present in the composition in an amount from about 2.0% (w/w) to about 4.0% (w/w).

29. A method for treating a leather article, comprising: applying onto the article the composition of claim 1.

30. The method of claim 29, wherein the leather article is a leather saddle.

31. The method of claim 29, wherein the oil is soybean oil.

32. The method of claim 29, wherein the wax is beeswax.

33. The method of claim 29, further comprising a thickener.

34. The method of claim 33, wherein the thickener is selected from the group consisting of carbomer, stearic acid, cetyl alcohol, and combinations thereof.

35. The method of claim 29, further comprising a neutralizer.

36. The method of claim 35, wherein the neutralizer is triethanolamine

37. A process for the preparation of an emulsion composition including water and having oil and wax obtained from natural sources, comprising:
adding the oil and wax to a container;
stirring the oil and wax with sufficient heat to form a mixture;
allowing the mixture to cool;
adding one or more thickeners and one or more neutralizers to the mixture with stirring; and
rapidly cutting the water into the mixture to complete the emulsion.

38. The process of claim 37, wherein the oil and wax are heated to at least about 170° F.

39. The process of claim 37, wherein the step of stirring the oil and wax is performed by a stirring device having an impeller.

40. The process of claim 39, wherein the stirring speed of the impeller is at least about 120 RPM.

41. The process of claim 37, wherein the rapid cutting is performed by a stirring device having a blade for cutting the mixture. The process of claim 41, wherein the blade has alternating teeth with angled leading and trailing edge profile.

43. The process of claim 41, wherein the stirring speed of the blade is at least about 450 RPM.

44. The process of claim 37, wherein the oil is soybean oil.

45. The process of claim 37, wherein the wax is beeswax.

46. The process of claim 37, wherein the thickener is selected from the group consisting of carbomer, stearic acid, cetyl alcohol, and combinations thereof.

47. The process of claim 37, wherein the neutralizer is triethanolamine.

48. The process of claim 37, wherein the emulsion is a water-in-oil emulsion.

49. The process of claim 37, wherein the emulsion is a semi-solid.
